(19) United States
(12) Patent Application Publication
(10) Pub. No.: US 2024/0017442 A1
(43) Pub. Date: Jan. 18, 2024

(54) REINFORCED INSULATED STRUCTURAL PANELS

(71) Applicant: DDP SPECIALTY ELECTRONIC MATERIALS US, LLC, Wilmington, DE (US)

(72) Inventors: JARRETT B. DAVIS, SALISBURY, NC (US); RANDAL HOFFNER, SALISBURY, NC (US)

(21) Appl. No.: 18/343,044

(22) Filed: Jun. 28, 2023

Related U.S. Application Data
(60) Provisional application No. 63/389,968, filed on Jul. 18, 2022.

(51) Int. Cl. B28B 23/02; B32B 9/04; B32B 37/12; B32B 37/18

(52) U.S. Cl. CPC B28B 23/02; B32B 9/045; B32B 37/12; B32B 37/182; B32B 2250/40; B32B 2375/00; B32B 2371/00; B32B 2607/00; B32B 2307/73

(57) ABSTRACT

A reinforced structural panel and a method of making said reinforced structural panel is described herein. The reinforced structural panel having an insulating layer, an outer layer adjacent a first lateral surface of the insulating layer, and a plurality of reinforcement structures fixed between the insulating layer and the outer layer. The reinforcement structures may be wood or a cementitious material, such as magnesium oxide. The outer layer of the reinforced structural panel may be any wood board or cementitious board, such as magnesium oxide or gypsum. The plurality of reinforcement structures may run parallel with the length or width of the structural panel. The plurality of reinforcement structures may be attached, at least partially, to the outer layer with an adhesive.

### FIELD

This disclosure relates generally to reinforced structural panels for use in the field of building construction and building construction materials.

### BACKGROUND OF THE INVENTION

Structural insulated sheathing (SIS) panels can be used in standard construction practice. Such panels typically consist of an insulating core and one or more structural layers. The structural layer may be a wood or wood composite material, such as oriented strand (OSB) board, or plywood; cementitious material such as magnesium oxide, or gypsum; steel; aluminum; and fiber-reinforced plastic. The use of SIS panels offers many advantages over traditional construction that consists of framing and scaffolding. As such panels are made off-site, assembly is significantly quicker and labor costs are significantly lower; and their use in a wall, roof, or structure helps provide. a more energy-efficient structure.

Cladding such as siding or shingles, etc. are typically secured to SIS via fasteners, and it is desirable and that the fasteners adequately secure the cladding to the SIS. In particular, it is desirable that the SIS help prevent the withdrawal of the fastener in the final wall or structure. and that the SIS has improved mechanical integrity. It is believed that increased fastening withdrawal properties and shear values of the SIS will allow better performance and new applications for the SIS; for example, use in high-wind zones, heavy weight claddings, or roof attachments.

While metal strip reinforcements might be used in panels, metal can be subject to corrosion resulting from water ingress into the board, either by damage to the board during construction or from poorly-sealed openings in the boards, and other types of chemical corrosion are possible.

What is needed, therefore, is a panel, particularly an insulated panel suitable for use as structural insulated sheathing (SIS), that is provided with increased fastening withdrawal properties and mechanical integrity when used with cladding without the risk of corrosion.

### BRIEF SUMMARY

Consistent and attuned with the present disclosure, a reinforced structural panel and a method of making said reinforced structural panel is disclosed.

In one aspect, a reinforced structural panel is claimed. The reinforced structural panel having an insulation layer, an outer layer adjacent a first lateral surface of the insulation layer, and a plurality of reinforcement structures within the reinforced structural panel. The plurality of reinforcement structures are fixed between the insulating layer and the outer layer. The reinforcement structures may be wood or a cementitious material.

In some embodiments, the reinforced structural panel may further include an additional outer layer on the opposite lateral side of the insulation layer. In further embodiments, the additional outer layer may comprise an additional plurality of reinforcement structures fixed between the insulation layer and the additional outer layer.

In some embodiments, each of the reinforcement structures may be equal in length to the outer layer. Additionally, or alternatively, each of the reinforcement structures may be greater than or equal to one inch wide and less than or equal to twelve inches wide. In some embodiments, each of the reinforcement structures may be greater than or equal to two inches wide and less than or equal to five inches wide. In some embodiments, each of the reinforcement structures may be greater than or equal to two inches wide and less than or equal to three inches wide. In some embodiments, the depth of each of the reinforcement structures is greater than or equal to 0.25 inch and less than or equal to 1.5 inch. Additionally, or alternatively, each of the reinforcement structures has a density equal to the density of the outer layer. In some embodiments, each of the reinforcement structures has a density greater than the density of the outer layer.

In some embodiments, the external surface of the outer layer may contain markings indicating the location of each of the reinforcement structures. Additionally, or alternatively, the external surface of the outer layer may contain a water-resistant barrier. In some embodiments, the outer layer comprises magnesium oxide. In some embodiments, the outer layer comprises gypsum. Additionally, or alternatively, the outer layer comprises cementitious board. In some embodiments, the outer layer and each of the reinforcement structures comprise magnesium oxide. In some embodiments, the insulating layer comprises polyurethane.

In another aspect, a method of making reinforced structural panels is claimed. The method of making reinforced structural panels including adhering a plurality of reinforcement structures, comprised of wood or cementitious material, to a surface of a board and applying an insulating layer to the plurality of reinforcement structures and the surface of the board. In some embodiments, the board may be wood, gypsum, magnesium oxide, or cement. In some embodiments, the method further includes forming a reinforcement structure.

In some embodiments, the method further includes applying a second board to the insulating layer. In further embodiments, the second board may first be adhered with a plurality of reinforcement structures. In some embodiments, the method further includes applying a water-resistant barrier to an outward-facing surface of the board.

In another aspect, a method of forming a reinforcement structure is claimed. The method of forming a reinforcement structure including: obtaining a panel of wood or cementitious material; and cutting, from the panel, a strip of the same length as the panel. In some embodiments, the strip is between one and twelve inches wide. Additionally, or alternatively, the strip may between two and four inches wide.

In some embodiments, the method of forming a reinforcement structure further includes forming the panel. Forming the panel includes: pouring a slurry of uncured cementitious product into a mold and curing the cementitious product. In some embodiments, the slurry of uncured cementitious product comprises magnesium oxide and glass fiber. In some embodiments, the method of forming a reinforcement structure includes applying an adhesive to the strip.

In another aspect, a reinforced structural panel is claimed. The reinforced structural panel having an insulation layer, an outer layer comprising magnesium oxide adjacent a first lateral surface of the insulation layer, and a plurality of reinforcement structures comprised of magnesium oxide within the reinforced structural panel. The plurality of reinforcement structures are fixed between the insulating layer and the outer layer.

In another aspect, a reinforced structural panel is claimed. The reinforced structural panel having an insulation layer, an outer layer comprising gypsum adjacent a first lateral surface of the insulation layer, and a plurality of reinforcement structures comprised of magnesium oxide within the reinforced structural panel. The plurality of reinforcement structures are fixed between the insulating layer and the outer layer.

In another aspect, a reinforced structural panel is claimed. The reinforced structural panel having an insulation layer, an outer layer comprising wood adjacent a first lateral surface of the insulation layer, and a plurality of reinforcement structures comprised of magnesium oxide within the reinforced structural panel. The plurality of reinforcement structures are fixed between the insulating layer and the outer layer.

In another aspect, a reinforced structural panel is claimed. The reinforced structural panel having an insulation layer, an outer layer comprising cementitious board adjacent a first lateral surface of the insulation layer, and a plurality of reinforcement structures comprised of magnesium oxide within the reinforced structural panel. The plurality of reinforcement structures are fixed between the insulating layer and the outer layer.

### BRIEF DESCRIPTION OF THE DRAWINGS

The drawings described herein are for illustrative purposes for selected embodiments and not all possible implementations, and are not intended to limit the scope of the present disclosure.

FIG. 1 is a perspective view of a reinforced structural panel in accordance with an embodiment of the present invention.

FIG. 2 is a sectional view of the reinforced structural panel of FIG. 1 taken along site line 2-2 therein.

FIG. 3 is a sectional view of a reinforced structural panel in accordance with an embodiment of the present invention.

FIG. 4 is a sectional view of a reinforced structural panel in accordance with an embodiment of the present invention.

FIG. 5 is a sectional view of a reinforced structural panel in accordance with an embodiment of the present invention.

FIG. 6 is a perspective view of a reinforced structural panel in accordance with an embodiment of the present invention.

### DETAILED DESCRIPTION OF EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

It must be noted that, as used in the specification and the appended claims, the singular forms “a,” “an” and “the” include plural referents unless the context clearly dictates otherwise.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The reinforcement within the panel is designed to improve the strength and mechanical integrity of the outer layer, and therefore the SIS as a whole. The reinforcement measures within the panel allow for commonly accepted engineering design to be utilized for the cladding attachment loads in higher wind zones equivalent to a structural facer while maintaining greater thermal efficiency as the insulation is truly continuous as defined within the IECC (International Energy Conservation Code) as a material that is unbroken except mechanical openings and fasteners. Since the fasteners used to attach the sheathing to the stud will likely be installed through the reinforcement measures, the outer reinforcement measures then become the structural face and maintaining greater than 97% thermal efficiency.

Due to the manufacturing process of a composite panel with adhered and/or fused insulation, it is possible to place a structural reinforcement strip of 1″-12″ in width made up of magnesium oxide or wood behind the sheathing facer of gypsum, wood, or magnesium oxide prior to attachment of the insulation. The insulation then affixes the structural reinforcement strips against or within 0.25 inches of the surface of the outer layer.

This reinforcement strips combined with the outer layer serve to spread the point load of a cladding fastener over the wall panel in a distributed load. This load spreading allows the cladding fastener withdrawal force to increase in a non-linear manner over the traditional methodology of only a single sheet panel, and often times increasing the shear and withdrawal values to double or greater the single sheet values.

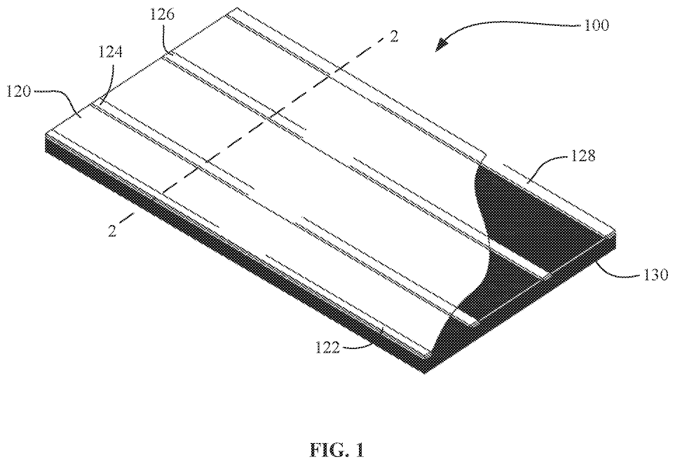

The wall panel described herein is a reinforced structural panel used as a structural insulated sheathing (SIS) or structural insulated panel (SIP). Referring to FIG. 1, the reinforced structural panel may include an insulation layer 130, an outer layer 120 and a plurality of reinforcement structures 122, 124, 126, and 128 on an inner surface of the outer layer 120. As illustrated in the sectional view of FIG. 2, the reinforcement structures are enclosed or embedded in an insulation layer 130 on the surface of the outer layer 120. The outer layer may comprise magnesium oxide, gypsum, wood, or other cementitious material. “Magnesium oxide” as used herein is meant to include magnesium oxychloride or magnesium oxysulphate or magnesium oxyphosphate or combinations thereof, which can optionally include fillers (such as perlite, etc.) and other additives such as water resistance and processing additives.

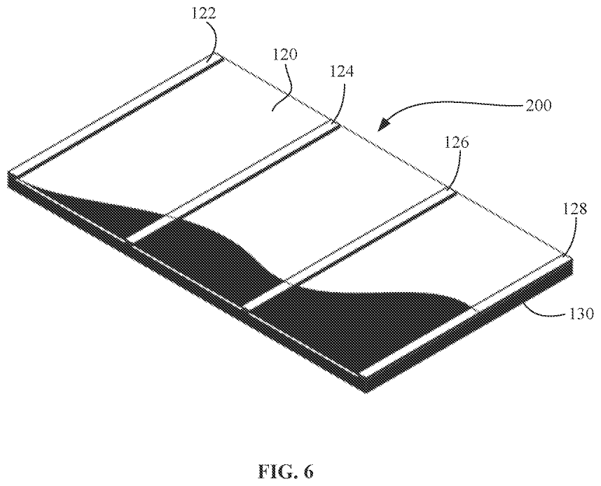

The reinforcement structures are narrow strips of wood or cementitious material affixed to the inner surface of the outer layer 120. The panel face can have a surface with a major dimension and a minor dimension. In some preferred embodiments, the reinforcement structures are parallel to the major panel dimension, as illustrated by reinforced structural panel 100 in FIG. 1. In some embodiments, the reinforcement structures are parallel to the minor panel dimension, as illustrated by reinforced structural panel 200 in FIG. 6. Additionally, or alternatively, the reinforcement structures are the same length as the major panel dimension. In some other embodiments, the reinforcement structures are the same length the panel minor panel dimension. In some embodiments, the reinforcement structures are spaced evenly along the width of the inner surface of the outer layer. In some embodiments, the reinforcement structures are spaced evenly along the length of the inner surface of the outer layer.

In one example, wherein the panel is four foot wide, there are four reinforcement structures placed evenly every sixteen inches. In this example, the edge of the first reinforcement structure is placed at an edge of the panel and sixteen inches from the edge of the panel the center of the second reinforcement structure is fixed. The center of the third reinforcement structure is fixed sixteen inches from the center of the second reinforcement structure, and the edge of the fourth reinforcement structure is placed at the second edge of the panel, sixteen inches from the center of the third reinforcement structure. Although a four foot wide panel is described in the example above, the invention is not limited to the exemplary dimensions described.

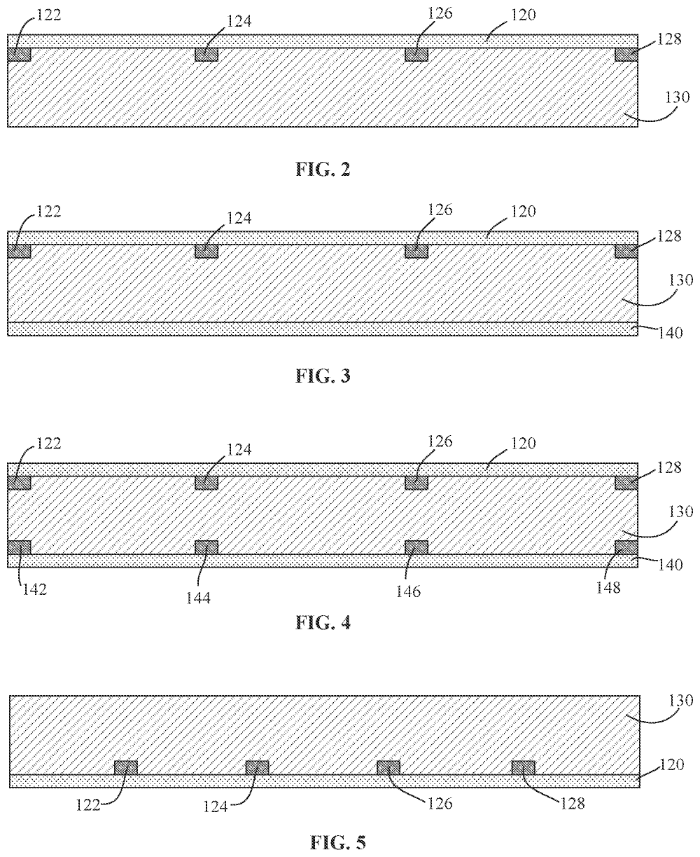

In some embodiments, the reinforced structural panel may include an additional outer layer 140, as illustrated in the sectional view in FIG. 3. The embodiment illustrated in FIG. 3 includes, opposite to outer layer 120, a second outer layer 140. In some embodiments, the additional outer layer 140 may further include reinforcement structures, as illustrated in the sectional view in FIG. 4. The additional outer layer 140 may have additional reinforcement structures 142, 144, 146, and 148. In some embodiments, the reinforcement structures are positioned at the edge of the panel as shown in the sectional views of FIGS. 2-4. Additionally, or alternatively, the reinforcement structures are not positioned at the edge of the panel as shown in the sectional view of FIG. 5.

The reinforcement structures may be comprised of wood or cementitious material. The use of cementitious material, such as magnesium oxide, as a reinforcement structure, provides a reinforcement structure that is fire-retardant. When combined with a fire-retardant outer layer, such as an outer layer comprised of magnesium oxide, the reinforced structural panel is entirely fire-retardant.

The reinforced structural panel may also be configured to be water resistant. In some embodiments, the reinforced structural panel may further comprise a water-resistant barrier (WRB). The WRB may be applied to the outward-facing surface of the outer layer of the reinforced structural panel.

The reinforced structural panel described herein may be manufactured by adhering a plurality of reinforcement structures onto a first surface of a board. The board serves as the outer layer of the reinforced structural panel. In some embodiments, the reinforcement structures may be adhered at regular intervals and may be evenly-spaced over the width of the board. In some embodiments, the reinforcement structure may be between one inch and twelve inches wide. Additionally, or alternatively, the reinforcement structure may be between one inch and ten inches wide. In some embodiments, the reinforcement structure may be between one inch and eight inches wide. Additionally, or alternatively, the reinforcement structure may be between one inch and six inches wide. In some embodiments, the reinforcement structures are between one inch and four inches wide. Additionally, or alternatively, the reinforcement structures are between two inches and four inches wide. In some embodiments, the reinforcement structure has the same length as the board.

The board forming the outer layer, or outer layers, may comprise magnesium oxide, gypsum, wood, or cementitious material. “Cementitious material” is meant to include materials containing magnesium oxide as defined herein, or other cement types, such as Portland cement; or any mixtures thereof of these materials. “Wood”, as used herein, is understood to include oriented strand board (OSB) or other composite materials containing wood products or wood byproducts or plywood. The board forming the outer layer, or outer layers, may contain magnesium oxide. In some embodiments, the board forming the outer layer, or outer layers, may further comprise gypsum. Additionally, or alternatively, the board forming the outer layer, or outer layers may fully comprise gypsum.

In some embodiments, the outer layer may be a board made of a cementitious material with a glass fiber reinforcing material embedded therein. Additionally, or alternatively, the board may be formed by pouring a slurry of cementitious material with glass fiber reinforcing material into a mold and allowing the cementitious product to cure, or dry. The glass fiber reinforcing material can be in the form of chopped glass fiber. Additionally, or alternatively, the glass fiber reinforcing material may be incorporated into the board in the form of one or more glass fiber scrim(s). Once cured, the board may be removed from the mold prior to adhering the reinforcement structures to the inner surface of the board.

After adhering the reinforcement structures to the board, an insulating layer is applied over the reinforcement structures and the first surface, or inner surface, of the board. The insulating layer serves as the primary mechanism for holding the reinforcement structures in place. In some embodiments, the insulation layer is injected at a high pressure, therefore the use of an adhesive to apply the strips to the board may be required to prevent the reinforcement structures from dislodging and “floating” during the application of the insulation layer.

The insulating layer may be between one inch and three inches thick or greater depending on the application. In some embodiments, the insulating layer is two inches thick. In some embodiments, the insulating layer comprises polyurethane or polyester. In some embodiments, the insulating layer may comprise polystyrene. Examples of polystyrene insulation include expanded polystyrene foam and extruded polystyrene foam. Additionally, or alternatively, the insulating layer may comprise a polyisocyanurate, polyurea, phenolic foam or an organic aerogel. In some embodiments, the insulating layer may comprise an inorganic insulating material, such as mineral wool, glass wool, compressed fumed silica, perlite, calcium silicate, foamed glass or silica aerogel blanket. In some embodiments, the insulating layer can be a machined, pre-made foam containing slots of a suitable size for surrounding and affixing the reinforcement structures to the outer layer. In some embodiments, the insulating layer may comprise mineral wool. In some embodiments, the insulating layer may be a rigid pour foam or injected formed from a two-part Class I rated urethane.

In some embodiments, wherein the reinforced structural panel comprises a second outer layer, a second board may be applied. In some embodiments, the second board is applied after the application of the insulation layer. In some embodiments, the second board is applied prior to the application of the insulation layer, and the insulation layer is applied between the two boards. In some embodiments, prior to applying the second board, an additional plurality of reinforcement structures is adhered to the second board in the manner previously described.

The reinforcement structures may be formed by obtaining a panel of wood or cementitious material. In some embodiments, the panel may be the same board of the outer layer of the reinforced structural panel. In other embodiments, the panel may be different from the board of the outer layer of the reinforced structural panel. After obtaining a panel, the method continues with cutting, from the panel, a strip. The strip may be the same length as of either the major surface dimension or the minor surface dimension of the panel as previously described herein. The strip may have a width between one inch and twelve inches. In some embodiments, the strip may have a width between one inch and ten inches. In some embodiments, the strip may have a width between one inch and eight inches. In some embodiments, the strip may have a width between one inch and six inches. In some embodiments, the strip may have a width between one inch and four inches. Additionally, or alternatively, the strip may have a width between two inches and five inches. Additionally, or alternatively, the strip may have a width between two inches and three inches. The depth of the reinforcement structure is determined by the panel that the strip is cut from. In some embodiments, the reinforcement structure has a depth of about 0.25 inch to about 1.5 inch. Additionally, or alternatively, the reinforcement structure is about 0.5 inch in depth.

In some embodiments, where the reinforcement strip comprises cementitious material, the panel is cut from a composite cementitious panel. In some embodiments, the composite cementitious panel may be made from a slurry of uncured cementitious material, such as magnesium oxide, with a glass fiber reinforcing material embedded therein. The slurry may be poured into a mold and cured, or dried. Once cured, the panel may be removed from the mold. The composite cementitious panel may be about 0.25 inch to about 1.5 inch thick. In some embodiments the composite cementitious panel is about 0.5 inch thick.

In some embodiments, where a reinforced structural panel that is water-resistant is desired, a water-resistant barrier (WRB) may be applied to an external surface of the outer layer. The WRB may be any commercially available WRB known in the art. In some embodiments, the WRB may be a liquid applied to the surface via spraying, painting, or coating. Additionally, or alternatively, the WRB may be a sheet that is adhered to the surface.

If the WRB is in sheet form, preferred WRB sheets meet the requirements of building codes, such as ASTM E2556, Standard Specification for a WRB. This code requires a dry tensile strength (both machine direction and cross direction (MD/CD)) per ASTM D828 of at least 20 pounds force per inch, and a water resistance, per AATCC 127 (held at 55 cm), of no leakage in 5 hours. Useful WRB sheets are generally any sheet material that does not allow or restricts movement of liquid water through the sheet but does allow some movement through the sheet of vapor, particularly water vapor. In some embodiments, the WRB sheet is polymeric. Preferred polymeric sheets are polyethylene (PE) or polypropylene (PP). One preferred WRB sheet is a nonwoven fibrous web of flash-spun plexifilamentary high-density PE (HDPE) fibers available from DuPont, Wilmington, DE sold under the tradename Tyvek® Homewrap™ or Tyvek® CommercialWrap. A suitable polypropylene substrate is available under the tradename Typar® Building Wraps. Alternatively, if the WRB is a coating on the outer layer, the coating is preferably a polymeric coating having a vapor permeability that is greater than the vapor permeability of the insulating layer, as determined in accordance with ASTM E96/E96M-22. Preferably the coating comprises a polymer made with either an acrylate monomer, a styrene monomer, or some combination thereof.

While the materials and methods of the present disclosure were described with reference to a number of embodiments, it will be understood by one of ordinary skill in the art that the present invention is not limited to the disclosed embodiments. Rather, the invention may be modified to incorporate any number of variations, alterations, and substations not described herein but that are commensurate with the scope of the invention.

### Example

To demonstrate the improved fastener pullout performance of structures that include the reinforcement structures, reinforced boards were made and tested per ASTM D1761-20, Standard Test Methods for Mechanical Fasteners in Wood, with variances from method being the crosshead speed was 0.5″/minute. Concealor® #10-9×1⅝″ screw fasteners were obtained from the manufacturer and tested as received. Reinforcement structures in the form of strips having a width of 4.5″ were cut from one 4′×8′ board made of magnesium oxide board having an embedded fiberglass scrim. The strips were then used to make structural insulated sheathing (SIS) comprising an outer layer of board made of magnesium oxide board having an embedded fiberglass scrim, the strips adjacent and spaced apart on the outer layer, and a foam holding the strips in place. The final SIS had a thickness of 2.75″. To show the improved performance, fasteners were then screwed into the outer board and also into and through the adjacent strips. As a control, fasteners were only screwed into the outer board and into the foam, missing the strips of reinforcement. The screws were not screwed flush to the surface of the outer layer, but to a depth that left a portion of the fastener exposed exterior to the outer layer for a testing fixture to grab the fastener. The fasteners were then removed from the SIS using on a Shimadzu AGS-X 10 kN Universal Test Machine (Part Number 337-01261-21) operating a 10,000 Newton load cell (Model SSM-DAL-10KN) at a crosshead speed of 0.5 in./min. All conditioning of the test specimens and test conditions were at the standard laboratory conditions of 72° F.±5.0° F. and 50%±10% relative humidity.

It was found that in some instances the addition of the foam, which was placed on the outer layer of magnesium oxide board and the reinforcement structures (strips), actually pushed the strips away from being in contact with the board in certain areas as the foam expanded in the making of the SIS.

It was found that the force to remove fasteners (the withdrawal force) that were screwed into the outer board and also into and through the adjacent strips, that were additionally fixed in place by the insulation in surface contact with the outer board, had an increase in the in the withdrawal force of 139 percent, when compared to the force to remove fasteners that were only screwed into the outer board and the foam. It was also found that the force to remove fasteners that were screwed into the outer board and also into and through the adjacent strips, that were additionally fixed in place by the insulation in surface contact with the outer board, had an increase in the in the withdrawal force of 185 percent, when compared to the force to remove fasteners that were only screwed into the outer board. These increase in fastener pullout performance were unexpected, as while the use of the reinforcement structures doubles the amount of board material (an increase of 100%) the actual performance was much higher. Additionally, this performance was obtained with little additional weight added to the SIS.

An additional unexpected result was that it was found that the force to remove fasteners (the withdrawal force) that were screwed into the outer board and also into and through the adjacent strips, wherein the strips had been pushed away 0.25 inches from being in surface contact with the board in certain areas as the foam expanded in the making of the SIS, but were additionally fixed in place by the insulation, also showed unexpected fastener pullout performance. These fasteners had an increase in the withdrawal force of 123 percent, when compared to the force to remove fasteners that were only screwed into the outer board and the foam; and further had an increase in the in the withdrawal force of 166 percent, when compared to the force to remove fasteners that were only screwed into the outer board.

1. A reinforced structural panel, wherein the reinforced structural panel comprises:
an insulating layer;
an outer layer adjacent a first lateral surface of the insulating layer; and
a plurality of reinforcement structures within the reinforced structural panel,
wherein the plurality of reinforcement structures is fixed between the insulating layer and an inner surface of the outer layer, and wherein the plurality of reinforcement structures comprise wood or cementitious material;
wherein each reinforcement structure of the plurality of reinforcement structures comprises a length, and wherein the length of each reinforcement structure is equal to either a length or a width of the outer layer.

2. The reinforced structural panel according to claim 1, wherein the reinforced structural panel further comprises a second outer layer adjacent a second lateral surface of the insulating layer.

3. The reinforced structural panel according to claim 2, wherein the reinforced structural panel further comprises a second plurality of reinforcement structures within the reinforced structural panel, wherein the second plurality of reinforcement structures are fixed between the insulting layer and an inner surface the second outer layer, and wherein the second plurality of reinforcement structures comprise wood or cementitious material.

4. (canceled)

5. The reinforced structural panel according to claim 1, wherein each reinforcement structure of the plurality of reinforcement structures comprises a width, and wherein the width of each reinforcement structure is greater than or equal to one inch and less than or equal to twelve inches.

6. The reinforced structural panel according to claim 5, wherein the width of each reinforcement structure is between greater than or equal to two inches and less than or equal to five inches.

7. The reinforced structural panel according to claim 6, wherein the width of each reinforcement structure is between greater than or equal to two inches and less than or equal to three inches.

8. The reinforced structural panel according to claim 1, wherein each reinforcement structure of the plurality of reinforcement structures comprises a depth, and wherein the depth is greater than or equal to 0.25 inch and less than or equal to 1.5 inch.

9. The reinforced structural panel according to claim 1, wherein each of the reinforcement structures of the plurality of reinforcement structures has a density greater than a density of the outer layer.

10. (canceled)

11. The reinforced structural panel according to claim 1, further comprising, on an external surface of the outer layer, markings indicating a location of each reinforcement structure, of the plurality of reinforcement structures.

12. The reinforced structural panel according to claim 1, wherein the outer layer comprises magnesium oxide.

13. The reinforced structural panel according to claim 1, wherein the outer layer comprises gypsum or wood.

14. (canceled)

15. The reinforced structural panel according to claim 1, wherein the outer layer comprises cementitious material.

16. The reinforced structural panel according to claim 1, further comprising, on an outer surface of the outer layer, a water-resistant-barrier.

17. The reinforced structural panel according to claim 1, wherein both the outer layer and the plurality of reinforcement structures comprise magnesium oxide.

18. The reinforced structural panel according to claim 1, wherein the insulating layer comprises polyurethane or polyester.

19. A method of making a reinforced structural panel, the method comprising:
placing a plurality of reinforcement structures onto a first surface of a board, wherein the plurality of reinforcement structures comprises wood or cementitious material; and
applying an insulating layer to the plurality of reinforcement structures and the first surface of the board.

20. The method of making a reinforced structural panel according to claim 19, wherein the method further comprises applying, to the insulating layer, a second board.

21. The method of making a reinforced structural panel according to claim 20, wherein the method further comprises, prior to applying the second board, adhering a plurality of reinforcement structures onto an inward-facing surface of the second board.

22. The method of making a reinforced structural panel according to claim 19, wherein the method further comprises applying, to an outward-facing surface of the board, a water-resistant barrier.

23. The method of making a reinforced structural panel according to claim 19, wherein the board comprises wood, gypsum, magnesium oxide, or cementitious material.

24. The method of making a reinforced structural panel according to claim 19, wherein the method further comprises forming a reinforcement structure, and wherein forming the reinforcement structure comprises:
obtaining a panel, wherein the panel comprises wood or cementitious material; and
cutting, from the panel, a strip, wherein the strip has a length that is the same as either the major surface dimension or the minor surface dimension of the panel, and wherein the strip has a width of greater than one inch and less than twelve inches.

25. The method of making a reinforced structural panel according to claim 24, wherein forming reinforcement structure further comprises forming the panel, and wherein forming the panel comprises:
pouring, into a mold, a slurry of uncured cementitious material; and
curing the slurry of uncured cementitious material.

26. The method of making a reinforced structural panel according to claim 25, wherein the slurry of uncured cementitious material comprises magnesium oxide.

27. The method of making a reinforced structural panel according to claim 19, wherein applying an insulating layer to the plurality of reinforcement structures and the first surface of the board comprises injecting a two-part urethane foam onto the plurality of reinforcement structures and the first surface of the board.

28. The method of making a reinforcement structure according to claim 19, further comprising applying an adhesive to the reinforcing structure prior to placing it onto the first surface of the board.

29. A reinforced structural panel comprising:
an insulating layer:
an outer layer adjacent to a first lateral surface of the insulating layer, wherein the outer layer comprises gypsum, wood, or cementitious material;
a plurality of reinforcement structures within the reinforced structural panel, wherein the plurality of reinforcement structures are fixed between the insulating layer and an inner surface of the outer layer, and wherein the plurality of reinforcement structures comprises magnesium oxide.

30. (canceled)

31. (canceled)

32. (canceled)

33. The reinforced structural panel of claim 30, wherein the cementitious material of the outer layer and reinforcement structures is magnesium oxide.
